(19) United States
(12) Patent Application Publication
(10) Pub. No.: US 2026/0059154 A1
(43) Pub. Date: Feb. 26, 2026

(54) SYSTEMS AND METHODS FOR VIDEO CONTENT DISTRIBUTION USING WATERMARKING

(71) Applicant: Warner Bros. Discovery, Inc., New York, NY (US)

(72) Inventor: Lakshmi NRUSIMHAN, Bangalore (IN)

(21) Appl. No.: 18/899,830

(22) Filed: Sep. 27, 2024

(30) Foreign Application Priority Data
Aug. 21, 2024 (IN) 202411063141

(51) Int. Cl. H04N 21/24; H04N 21/231; H04N 21/239; H04N 21/258; H04N 21/8358

(52) U.S. Cl. CPC H04N 21/2407; H04N 21/231; H04N 21/2393; H04N 21/25866; H04N 21/8358

(57) ABSTRACT

Systems and methods are disclosed for delivering video data. One method comprises receiving, by one or more processors, a first reference to a first video content item from a user device, generating a manifest request for a manifest associated with the first video content item, the manifest request comprising profile data associated with a user of the user device, wherein the profile data includes profile metadata, transmitting the manifest request to a server system, in response to the transmitting, receiving an additional video content item based on the manifest request from the server system, wherein the additional video content item includes metadata that matches the profile metadata, encoding the additional video content item with an embedded watermark, wherein the embedded watermark includes the profile metadata and a unique identifier associated with the user, and transmitting the encoded additional video content item to the user device.

### CROSS-REFERENCE TO RELATED APPLICATION(S)

This application claims the benefit of priority to Indian Patent Application No. 202411063141, filed on Aug. 21, 2024, the entirety of which is incorporated by reference herein.

### TECHNICAL FIELD

The present disclosure relates to improved techniques for video content distribution and, more particularly, to improved techniques for video content distribution utilizing watermarking processes.

### BACKGROUND

Content distribution systems may provide content video content managing capabilities. For example, content distribution systems may curate additional relevant content and/or provide such additional content to user devices. However, existing systems lack the ability to determine whether the additional content has been observed by user devices. For example, conventional systems may send additional video content to user devices. However, the conventional systems may not be able to confirm whether the additional content has been observed by a user of the user device. As a result, a need exists for a system to select additional content for a user, send the additional content to the user device, and then determine when a user is observing the additional content.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

Aspects of the present disclosure include systems and methods for delivering video data.

According to certain embodiments, computer-implemented methods are disclosed for delivering video data. The method may include receiving, by one or more processors, a first reference to a first video content item from a user device. The method may further include generating, by the one or more processors, a manifest request for a manifest associated with the first video content item, the manifest request comprising profile data associated with a user of the user device, wherein the profile data includes profile metadata. The method may further include transmitting, by the one or more processors, the manifest request to a server system. The method may further include, in response to the transmitting, receiving, by the one or more processors, an additional video content item based on the manifest request from the server system, wherein the additional video content item includes metadata that matches the profile metadata. The method may further include encoding, by the one or more processors, the additional video content item with an embedded watermark, wherein the embedded watermark includes the profile metadata and a unique identifier associated with the user. The method may further include transmitting, by the one or more processors, the encoded additional video content item to the user device.

According to certain embodiments, a computer system for delivering video data is disclosed. The computer system may comprise a memory having processor-readable instructions stored therein, and one or more processors configured to access the memory and execute the processor-readable instructions, which when executed by the one or more processors configures the one or more processors to perform a plurality of functions. The functions may include receiving, by one or more processors, a first reference to a first video content item from a user device. The functions may further include generating, by the one or more processors, a manifest request for a manifest associated with the first video content item, the manifest request comprising profile data associated with a user of the user device, wherein the profile data includes profile metadata. The functions may further include transmitting, by the one or more processors, the manifest request to a server system. The functions may further include, in response to the transmitting, receiving, by the one or more processors, an additional video content item based on the manifest request from the server system, wherein the additional video content item includes metadata that matches the profile metadata. The functions may further include encoding, by the one or more processors, the additional video content item with an embedded watermark, wherein the embedded watermark includes the profile metadata and a unique identifier associated with the user. The functions may further include transmitting, by the one or more processors, the encoded additional video content item to the user device.

According to certain embodiments, a non-transitory computer-readable medium containing instructions delivering video data is disclosed. The instructions may include receiving a first reference to a first video content item from a user device. The instructions may further include generating a manifest request for a manifest associated with the first video content item, the manifest request comprising profile data associated with a user of the user device, wherein the profile data includes profile metadata. The instructions may further include transmitting the manifest request to a server system. The instructions may further include, in response to the transmitting, receiving an additional video content item based on the manifest request from the server system, wherein the additional video content item includes metadata that matches the profile metadata. The instructions may further include encoding the additional video content item with an embedded watermark, wherein the embedded watermark includes the profile metadata and a unique identifier associated with the user. The instructions may further include transmitting the encoded additional video content item to the user device.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 depicts a schematic diagram illustrating an exemplary computing environment for video content delivery, according to one or more embodiments.

FIG. 2 depicts an exemplary signal flow for video content delivery, according to one or more embodiments.

FIG. 3 depicts a schematic diagram of an exemplary method for video content delivery, according to one or more embodiments.

FIG. 4 depicts an example computer system that may execute techniques presented herein, according to one or more embodiments.

### DETAILED DESCRIPTION OF EMBODIMENTS

Certain aspects of this disclosure relate to techniques for improved content distribution. Examples of video content may include, but are not limited to video content, multimedia content, and/or interactive content. In particular, certain embodiments may include utilizing watermarking to facilitate the delivery of interactive content to a user device.

As discussed above, in some cases, video content distribution systems may select or curate additional relevant video content for access by user devices. For example, content distribution systems may curate additional relevant content and/or provide such additional content to user devices. However, existing systems lack the ability to determine whether the additional content has been observed by user devices. For example, conventional systems may send additional video content to user devices. However, the conventional systems may not be able to confirm whether the additional content has been observed by a user of the user device. As a result, a need exists for a system to select additional content for a user, send the additional content to the user device, and then determine when a user is observing the additional content.

Certain aspects involve validating that content on a user device was actively viewed and/or was interacted with by a user. In some cases, disclosed systems may provide a mechanism through which analytics may be performed such as return on investment of video content expenditures. To facilitate such analytics, the disclosed systems and methods may leverage the watermarking of video content by using unique identifiers.

For example, a user operating a user device may request access to video content items, for example via an application or a set top box. A video content management system may receive the request and then curate or suggest, based on the requested video content items, additional video content items. The content management system may then watermark the additional video content items with a unique identifier that corresponds to a profile of the user. The content management system may then make the additional video content items available to the user device. When the user actively views or interacts with the additional content items, the user device may extract a watermark located within the content item, process the watermark, and then transmit an indication that a particular content item was viewed to the content management system.

In a more specific example, the systems and methods disclosed herein describe delivering video data. The systems and methods may include receiving, by one or more processors, a first reference to a first video content item from a user device. The systems and methods may include generating, by the one or more processors, a manifest request for a manifest associated with the first video content item, the manifest request comprising profile data associated with a user of the user device, wherein the profile data includes profile metadata. The systems and methods may include transmitting, by the one or more processors, the manifest request to a server system. The systems and methods may include, in response to the transmitting, receiving, by the one or more processors, an additional video content item based on the manifest request from the server system, wherein the additional video content item includes metadata that matches the profile metadata. The systems and methods may include encoding, by the one or more processors, the additional video content item with an embedded watermark, wherein the embedded watermark includes the profile metadata and a unique identifier associated with the user. The systems and methods may include transmitting, by the one or more processors, the encoded additional video content item to the user device.

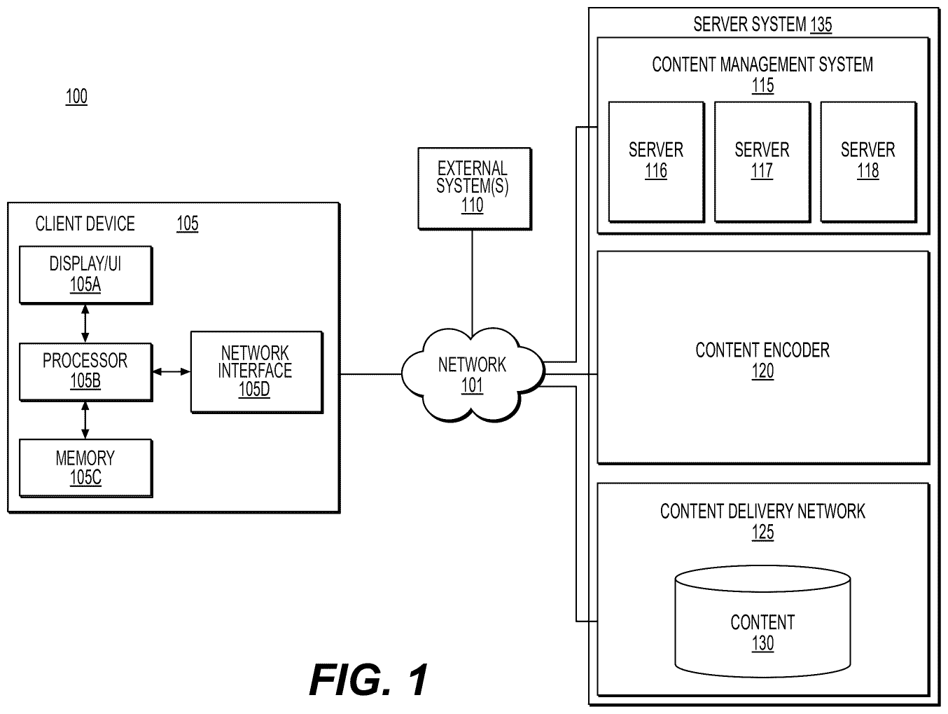

FIG. 1 depicts a schematic diagram illustrating an exemplary computing environment 100 for content delivery, according to one or more aspects. In the example depicted, the sever system 135, which may include the content management system 115, the content encoder 120, and/or the content delivery network 125, and/or one or more external system(s) 110 may communicate across a network 101 to facilitate delivery of content to a user device 105.

For instance, user device 105 (e.g., a user device) may be configured to enable a user to access and/or interact with systems in the environment 100, such as the server system 135. In an example, the user device 105 may request one or more content items (e.g., “first” content items) from the content management system 115 in the server system 135. In some cases, a request for content may be included into a manifest (or a “content manifest”). A manifest may include references to one or more items of content, user profile information, unique identifiers, and/or any other additional relevant information.

In turn, the content management system 115 can provide the content items to the user device 105, for instance, upon receiving a manifest. Additionally, the content management system 115 may curate, e.g., identify, one or more additional (or “second” content items) that may be relevant to the user operating the user device 105. The second content items may be related to the first content items and/or relevant to the user, for example, as identified from a profile of a user of user device 105. The server system 135 (e.g., the content management system 115) can then cause this additional content to be watermarked, for example, by using the content encoder 120. This additional content may then be provided to the user device 105. As described below, the content management system 115 can determine that the first content items and/or the second content items have been viewed and/or accessed by a user operating the user device 105 by using one or more watermarks. For instance, the user device 105 may extract a watermark from within a content item and process the watermark. Subsequently, at an appropriate time, the user device 105 may transmit an indication that a particular content item was viewed to the server system 135 (e.g., content management system 115). In some cases, the watermarking may facilitate providing additional interactive content to the user device 105.

User device 105 may be a computer system such as, for example, a desktop computer, a mobile device, a tablet, a Virtual Reality (VR) or Augmented Reality (AR) headset, a set-top-box, streaming box or stick, and so forth. In some aspects, the user device 105 may include one or more electronic application(s), e.g., a program, plugin, browser extension, etc., installed on a memory of the user device 105.

The electronic applications (“apps”) executing on user device 105 facilitate browsing, selection, and viewing of content. For instance, a user operating user device 105 may select a first video content item from a list or menu of content items. Then, the user device 105 transmits a request to the content management system 115, which in turn facilitates the first video content item being provided to the user device 105. The first video content item may be provided directly from the content management system 115 and/or from the content delivery network 125.

The user device 105 may be associated with one or more users. For instance, the user device 105 may be operated by a single user with a single profile, or be used by multiple users, e.g., via one or more profiles that can be selected. A profile may include information, or metadata, about the user, for example, such as demographic information (e.g., name, address, postal code, race, gender, and so forth), viewing information (e.g., past shows viewed, preferred genres, etc.), and/or any other relevant information.

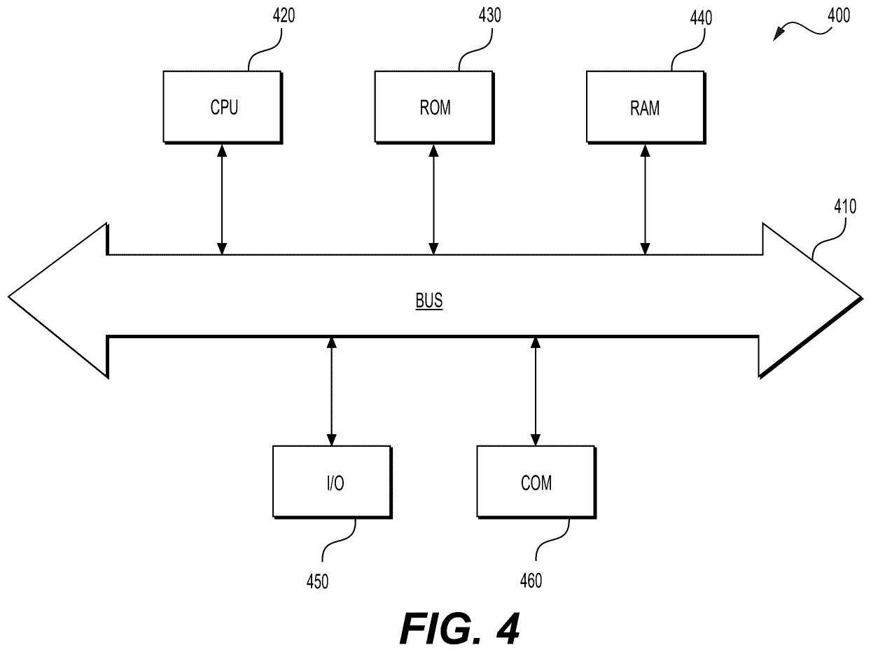

The server system 135, including the content management system 115 (including servers 116-118), the content encoder 120, and/or the content delivery network 125 may be implemented in hardware, software, or some combination thereof. Example hardware is depicted in FIG. 4. Example software may include virtualization software. For example, one or more servers may be virtualized in separate virtual machines on one server.

The content management system 115 may be configurable to manage content and perform related functions, including authenticating the user device 105, verifying content access permissions, recommending content to the user device 105, providing content to the user device 105, and so forth. The content management system 115 may include server 116, server 117, and/or server 118. While three servers are depicted in FIG. 1, the content management system 115 may include any number of servers. The server 116, server 117, and server 118 may be configured to perform different functions of the content management system 115.

The content delivery network 125 may be configurable to provide content items directly to the user device 105. The content delivery network 125 may include the content storage 130, which may include one or more content items. For example, the content delivery network 125 may provide these items to the user device 105 upon request. In other cases, the content delivery network 125 may provide a list of available content items to the user device 105.

The content encoder 120 may be configurable to encode, decode, and/or transcode video content items between video formats and/or raw formats. In an example, the content management system 115 may provide content items to the content encoder 120, and in turn, the content encoder 120 may encode these content items and return them to the content management system 115 and/or the user device 105. The content storage 130 may be located externally to the content delivery network 125.

Video content items may be encoded via one or more codecs to facilitate lower bandwidth usage. For example, a video content item may be encoded in MPEG2, MPEG4, H.264 (AVC), H.265 (HEVC), or any suitable codec. When provided a video content item, the user device 105 may decode the content for viewing. In some cases, content may be encoded adaptively, or may change coding over time, for example, if network conditions change.

As discussed, one or more systems disclosed herein may be configurable to watermark content items such as video content. A watermark may facilitate the identification of the content, a user who requested the content, and/or other metadata information. An example of a watermark may include data that may be stored, sometimes, covertly, i.e., not visible to the user, in a content item. The watermark may be noise-tolerant, in that errors in transmission that affect the watermark data can be recovered.

Watermarks can be embedded in images, video, audio, data files, and so forth. In the case of video, watermarks need not be embedded in every frame. For instance, w watermark may be embedded every n video frames, for example every 10 frames or 100 frames. In some cases, a watermark may be embedded at a specific location within a video, for instance, at the start of a particular segment of content within the video or at the end of the segment. In some cases, watermarks may be embedded in specific video frame types such as P-frames or I-frames. Watermarking may involve decoding part or all of an encoded video, applying the watermark, and then re-encoding the watermarked video.

In some aspects, the server system 135 (e.g., the content management system 115 and/or the content delivery network 125) may recommend and/or provide additional content such as videos to the user device 105. The additional content may be based on metadata, for example, metadata associated with a user profile. For instance, the content management system 115 may analyze metadata stored in a user profile to determine one or more additional content items that would be relevant to a user of the user device 105.

As depicted, user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, the environment 100 may extend information on a web client that may be accessed through a web browser. In some aspects, the electronic application may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages, and may further perform one or more operations prior to providing an output to the network 101. Other components are possible.

In some aspects, the components of the environment 100, e.g., content management system 115, content encoder 120, content delivery network 125, and one or more external system(s) 110, are associated with a common entity. In some aspects, one or more of the components of the environment are associated with a different entity than another. The systems and devices of the environment 100 may communicate in any arrangement. External systems 110 may be, for example, one or more third party and/or auxiliary systems that integrate and/or communicate with the content management system 115 in performing various query analysis tasks. External systems 110 may be in communication with other devices or systems in the environment 100 over the one or more networks 101. For example, external systems 110 may communicate with the server system 135 via API (application programming interface) access over the one or more networks 101, and also communicate with the user device 105 via web browser access over the one or more networks 101.

In various aspects, the network 101 may be a wide area network (“WAN”), a local area network (“LAN”), a personal area network (“PAN”), or the like. In some aspects, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Each of content management system 115, content encoder 120, and content delivery network 125 may be implemented on one or more servers (e.g., server system 135). A typical server system may include an electronic data system, e.g., a computer-readable memory such as a hard drive, flash drive, disk, etc. In some aspects, each server system includes and/or interacts with an application programming interface for exchanging data to other systems, e.g., one or more of the other components of the environment. Each server system may include one or more processors.

In some cases, the server may implement virtualization, e.g., execute one or more virtual machines. Each server system may generate, store, train, or use one or more machine-learning models. Each server system may include a deep learning model and/or instructions associated with the deep learning model, e.g., instructions for generating a deep learning model, training the deep learning model, using the deep learning model, etc. The server system may also include training data.

Although depicted as separate components in FIG. 1, a component or portion of a component in the environment 100 may, in some aspects, be integrated with or incorporated into one or more other components. In some aspects, operations or aspects of one or more of the components discussed above may be distributed amongst one or more other components. Any suitable arrangement and/or integration of the various systems and devices of the environment 100 may be used.

In these methods, various acts may be described as performed or executed by a component from FIG. 1, such as the server system 135, the user device 105, or components thereof. However, in various aspects, various components of the environment 100 discussed above may execute instructions or perform acts including the acts discussed above and below. An act performed by a device may be performed by a processor, actuator, or the like associated with that device. Further, in various aspects, various steps may be added, omitted, and/or rearranged in any suitable manner.

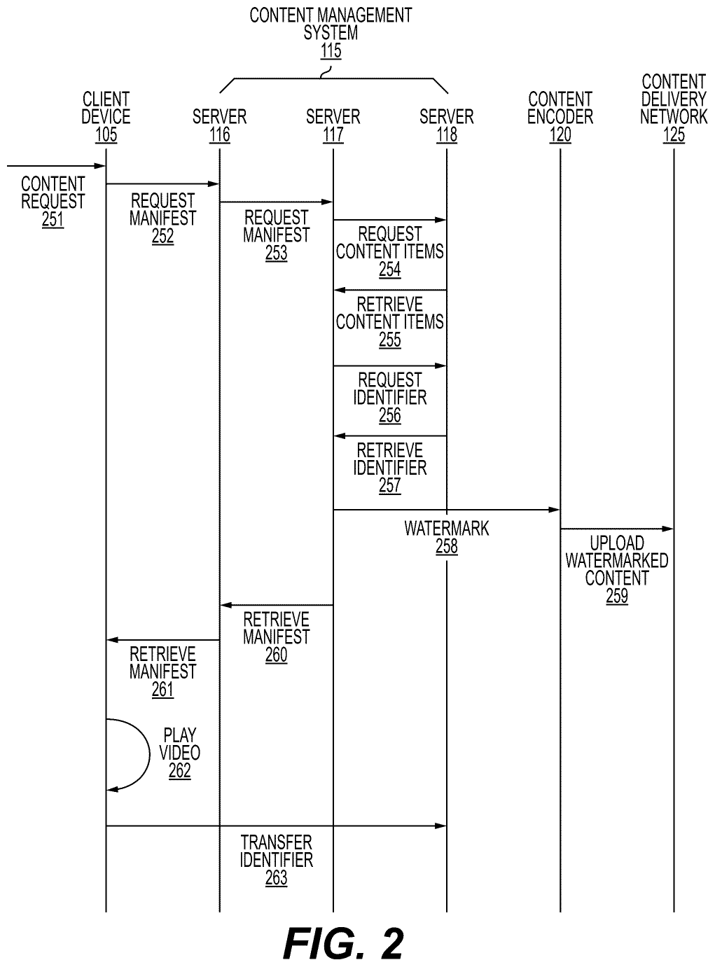

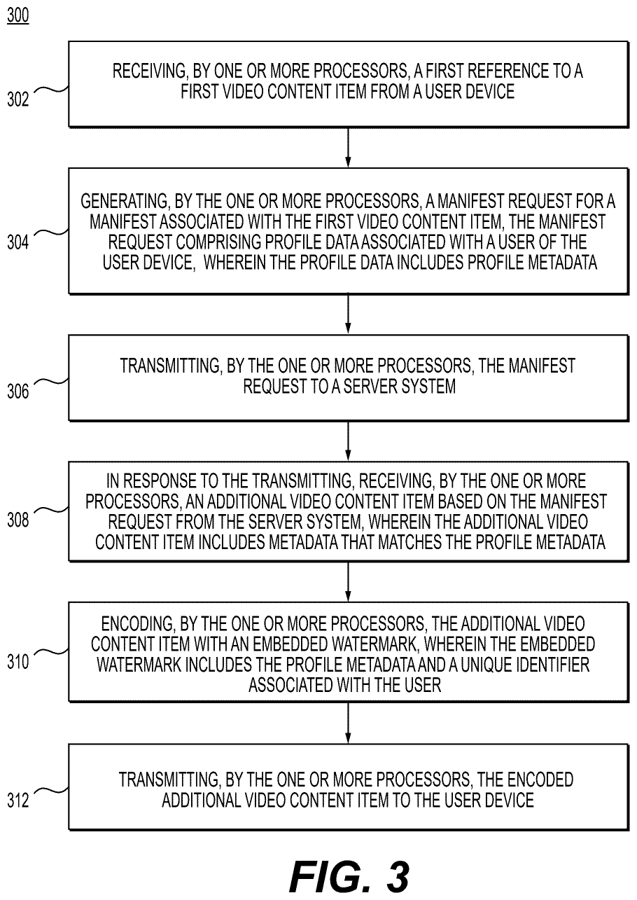

In general, any process or operation discussed in this disclosure that is understood to be computer-implementable, such as the methods illustrated in FIGS. 2-3, may be performed by one or more processors of a computer system, such any of the systems or devices in the environment 100 of FIG. 1, as described above.

A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

FIG. 2 depicts an exemplary signal flow 200 for video content delivery, according to one or more embodiments. Signal flow 200 may include various signal flows 251-263 between one or more of user device 105, content management system 115, content encoder 120, and/or content delivery network 125.

In the example depicted, the content management system 115 may manage various content items and facilitate the delivery, via content delivery network 125, of the content to the user device 105. For illustrative purposes, content management system 115 is depicted having three servers 116, 117, and/or 118. But any number of servers is possible. Further, each server 116, 117, and/or 118 may be hosted, managed, and/or owned by different entities.

Signal flow 251 may include a user of the user device 105 requesting a first content item from the user device 105. For example, a user executing an application on the user device 105 may browse and select a first content item. Various content items can be presented in the application in list form, grid form, menu form, etc. In some cases, the request originates via a Software Development Kit (SDK) or an Application Programming Interface (API). For instance, an application executing on a set top box device may use an SDK and/or API.

Signal flow 252 may include the user device 105 requesting a manifest from the server 116. As discussed above, the manifest may include various items such as a reference to the video content item, an identifier corresponding to the user and/or the user device 105, information regarding subscription or access status of the user and/or user device 105, and so forth. The manifest may also include a copy of the profile associated with the user of the user device 105, including a unique identifier of the user and/or the user device 105. The manifest may be created by server 216 and/or server 217.

Signal flow 253 may include the server 116 requesting the manifest from the server 117. In this example, the server 116 may transmit the request received from the user device 105 to the server 117. The server 116 may include, for example, a server-side video-insertion device or service. In one example, the video may include advertisements, but other examples are possible. The server 117 may include a return on investment (ROI) device or service. The server 117 may be operated by an external entity, such as a vendor of hardware such as set-top-box hardware or streaming hardware.

Continuing the example, the signal flow 254 may include the server 117 requesting one or more additional or “second” content items from the server 118. An example of the server 118 may include a supply side platform (SSP), a demand side platform (DSP), or an advertising company device or service. DSP may correspond to a piece of software that allows advertisers to access available advertising inventory. SSP software may enable publishers to make their inventory available to advertisers. In some cases, the server 118 may be an ad exchange, which may host multiple services.

Continuing the example, the server 117 may obtain a list of additional video content items that may correspond or relate in some way to the first content item requested from the server 118. A determination of relevancy may be based on matching profile data with data in each video content item in the list of content items. For example, determining the relevant content may involve matching one or more data points, ranges, and so forth in common between attributes associated with the user profile and attributes associated with the additional video content items. In one example, an additional video content item may be matched with a user profile because the video content item may be associated with a city, town, region, and/or postal code that matches a residential address or location of a user.

Continuing the example, signal flow 255 may include retrieving the second content items from the server 118. In some cases, the content items may be transferred from the server 118 to the server 117. In other cases, a reference or an identifier for each content item may be sent from the server 118 to the server 117.

Accordingly, signal flow 256 may include the server 117 requesting a unique identifier from the server 118. As explained below the unique identifier may be applied to a content item during watermarking. The identifier may include a unique identifier, e.g., an identifier that is unique to the user and/or the user profile. In some cases, this unique identifier may be referred to as a “SALT.” The unique identifier may enable the identification of the user of the user device 105 across devices and/or platforms. The unique identifier may be generated by the server 118. Continuing the example, signal flow 257 may include the server 118 transmitting the unique identifier back to the server 117.

In some cases, server 117 may generate the watermark based on the unique identifier and/or user profile information. For instance, the watermark may be generated by server 116 or server 118.

Continuing the example, the server 117 may transmit the watermark to the content encoder 120, as shown in signal flow 258. The content encoder 120 may then encode the second video content items with the watermark. The watermark may include encoded copies of the profile metadata, unique identifier, customer information, and/or billing information. Additional information is possible. In some cases, the watermark data may be encrypted.

When the encoding is complete, signal flow 259 may include the content encoder 120 uploading the watermarked content to a content delivery network 125. The manifest may be updated to reflect completion of watermarking and/or successful upload of the additional content. The manifest may be updated, for example, at the server 117, with references or links to the encoded second content items.

Signal flow 260 may include the server 117 transmitting the content manifest to the server 116. Signal flow 261 may include the server 116 transmitting the content manifest to the user device 105.

Signal flow 262 may include the user device 105 playing the video content items to the user, for instance on a display or screen. To obtain the video content items, the second device may generate a second reference to (or request for) one or more of the encoded second video content items and then transmit the reference to the content management system 115. In turn, the content management system 115 may transmit the requested second video content items from the video content distribution system to the user device 105.

When the content item is played on the user device 105, the user device 105 may extract the watermark, and from the watermark, extract a copy of the unique identifier. This unique identifier, when transmitted to the content management system 115, may provide an indication that the content items were actively viewed. In this content, “actively viewed” may include that the user had the user's attention on the content item and watched through a specific point in the content item (e.g., the end of the content item). Signal 263 may include the user device transmitting a copy of the unique identifier to the server 118.

In some cases, the content management system 115 may transmit an indication to an external device that the content was actively viewed. For instance, the content management system 115 may receive the copy of the unique identifier, and responsive to this receiving, transmit the indication to an external device.

In some aspects, disclosed solutions may facilitate downstream analytics. For instance, the content items may be encoded to include one or more embedded visual symbols or codes. These symbols or codes may include references to external resources and may be associated with and/or include the unique identifier.

Examples of external symbols may include codes, bar codes, quick-response (QR) codes, and the like. In some cases, a user may use another device such as a smart phone or tablet to scan the code, which may cause the device to follow the embedded link, for example, to a website or other external resource. Then, the server hosting the website may communicate to the content management system 115 that the user has followed the links. Because the symbol or code is associated with a unique identifier, the symbol or code may be associated with the user. In this manner, future transactions can be related back to the user. The unique identifier can be used multiple times.

FIG. 3 depicts a schematic diagram of an exemplary method 300 for delivering video data, according to one or more aspects. Exemplary method 300 may be executed on one or more components of FIG. 1 or 4. For example, method 300 may be performed by one or more processors of a server (e.g., server system 135) that may be in communication with one or more user devices (e.g., user device 105) and other external system(s) (e.g., external system(s) 110) via a network (e.g., network 101). However, it should be noted that method 300 may be performed by any one or more of the server, one or more user devices, or other external systems.

The method may include receiving, by one or more processors, a first reference to a first video content item from a user device (e.g., user device 105) (Step 302). For example, a user may operate the user device, which may trigger the user device sending the first reference to the system (e.g., server system 135). For example, as shown in FIG. 2, a user may interact with the user device 105 to input a content request 215 that includes a reference to a first video content item. For example, the user may select a first content item (e.g., a video, a picture, a video game, and the like) from a menu displayed on the user device (e.g., via display/UI 105A), where the reference may correspond to a unique identifier of the first content item.

The method may include generating, by the one or more processors, a manifest request for a manifest associated with the first video content item, the manifest request comprising profile data associated with a user of the user device, wherein the profile data includes profile metadata (Step 304). The manifest request may have been generated based on the first reference to the first video content item. In some embodiments, the video content management system (e.g., content management system 115) may receive the first reference from the user device, as shown in signal flow 252 in FIG. 2, where the first reference corresponds to a manifest request.

In some embodiments, the manifest request may include profile data of a profile associated with a user of the user device. The profile data may include profile metadata, which may include, for example, user profile information, user location, user device information, shared subscription data, content data, time data, and/or viewing data. The user profile information may include a user age, a user gender, and the like. The user location may include a user country, a user city, a user zip code, and the like. For example, the user location may correspond to a location of where the user device sends the manifest request. The user device information may include a user device profile. The shared subscription data may include user profile information of a shared subscription of video content. The content data may correspond to content genres viewed by the user. The time data may correspond to a time when the user logs in and views the video content. The viewing data may correspond to a length of time that the user views the video content. The server system may generate the manifest request based on the first video content item. For example, as shown in FIG. 2, the user device 105 may generate and send a manifest request 252 to server 116.

The method may include transmitting, by the one or more processors, the manifest request to a server system (e.g., server system 135) (Step 306). For example, as shown in FIG. 2, the server 116 may transmit the manifest request 253 to the server 117. In some embodiments, based on the content of the manifest, the server 117 may transmit a request for content items 254 to the server 118.

The method may include, in response to the transmitting, receiving, by the one or more processors, an additional video content item based on the manifest request from the server system, wherein the additional video content item includes metadata that matches the profile metadata (Step 308). For example, based on the request for the manifest, the method may include identifying, at the video content management system (e.g., content management system 115), one or more additional video content items based on the content of the manifest request. The additional video content item may include video data, one or more pictures, video game data, and the like. The additional video content item may include metadata that matches and/or is similar to the profile metadata. Identifying the additional video content item may include matching respective metadata with the metadata of the profile information. For example, as shown in FIG. 2, the server 117 may send a request for more content items 254 to the server 118, where the server 118 may identify and/or retrieve the additional video content item and then send the additional video content item 255 back to the server 117.

Additionally, or alternatively, in some embodiments, in response to the receiving, the method may include sending a request for a unique identifier corresponding to the additional video content item (e.g., to the content management system 115). For example, as shown in FIG. 2, the server 117 may send an identifier request 256 to the server 118. In response to receiving the request for the unique identifier, the server system may retrieve the unique identifier and send the unique identifier back to the server system. For example, as shown in FIG. 2, the server 118 may send the retrieved identifier 257 to the server 117.

The method may include encoding, by the one or more processors, the additional video content item with an embedded watermark, wherein the embedded watermark includes the profile metadata and a unique identifier associated with the user (Step 310). The watermark may include the profile information, a unique identifier associated with the additional video content item, a unique identifier associated with the user, and/or any additional information. For example, as shown in FIG. 2, the content encoder 120 may encode the additional video content item with the embedded watermark 258.

In some embodiments, encoding the additional video content item with the embedded watermark may include utilizing a dynamic invisible watermarking process. The dynamic invisible watermarking process may include dividing the additional video content item into one or more frames. The process may then include utilizing an algorithm to embed a dynamic invisible watermark into at least one of the frames. In some embodiments, the at least one of the frames may be selected randomly. Additionally, the dynamic invisible watermark may be generated and embedded in such a way that the dynamic invisible watermark may uniquely identify the user, user device, and/or a geographic profile of the user and/or the user device. Upon embedding the dynamic invisible watermark into the frame, the process may further include transmitting the frame with the embedded dynamic invisible watermark to the user device by placing the encoded information (e.g., a signature of the dynamic invisible watermark, the frame where the dynamic invisible watermark is placed, and the like) in a container (e.g., mp4, Audio Video Interleave, and the like) of the profile metadata information. In some embodiments, the process may further include generating a QR code based on a signature of the dynamic invisible watermark. The process may further include placing the dynamically generated watermark in a database (e.g., content delivery network 125) for transmission to the user device.

In some embodiments, encoding the additional video content item with an embedded watermark may further include encoding, by the one or more processors, an embedded visible symbol into one or more frames of the additional video content item, wherein the embedded visible symbol includes a reference to an external resource. For example, the embedded visible symbol may correspond the QR code described above.

In some embodiments, the method may include updating, by the one or more processors, the manifest corresponding to the manifest request with the profile metadata and a location of the encoded additional video content item within the server system. Updating the manifest may include updating the manifest with the profile information and/or a respective location of the additional video content item within the video distribution system. For example, the manifest may be updated to include references or links to the watermarked additional video content item. Additionally, the method may further include transmitting, by the one or more processors, the manifest to the user device. For example, as shown in FIG. 2, the server 117 may transmit the manifest 260 to server 116, and then server 116 may transmit the manifest 261 to the user device 105.

The method may include transmitting, by the one or more processors, the encoded additional video content item to the user device (Step 312). Upon receiving the encoded additional video content item, the user device may play the originally requested first content items, as shown in play video 262 of FIG. 2. Before, during, or after playback of the first content items, the user device 105 may be presented with the additional video content item.

In some embodiments, the method may include storing, by the one or more processors, the encoded additional video content item in one or more data stores of the server system. For example, as shown in FIG. 2, after encoding the additional video content, the content encoder 120 may upload, or transmit, the watermarked content 259 to the content delivery network 125.

In some embodiments, the method may include receiving, by the one or more processors, a copy of the unique identifier from the user device. The user device may transmit the copy of the unique identifier when the additional video content item has been played by the user device. For example, receiving the copy of the unique identifier may be responsive to the user device extracting the unique identifier from the embedded watermark (e.g., upon initialization of the frame that includes the embedded watermark). The copy of the unique identifier may be stored in one of more data stores of one or more systems (e.g., content management system 115, video content encoder 120, and/or content delivery network 125) for future analysis. For example, as shown in FIG. 2, the user device may transmit the identifier 263 to the server 118.

Further, although FIG. 3 shows example blocks of exemplary method 300, in some implementations, the exemplary method 300 may include additional blocks, fewer blocks, different blocks, or differently arranged blocks than those depicted in FIG. 3. Additionally, or alternatively, two or more of the blocks of the exemplary method 300 may be performed in parallel.

FIG. 4 illustrates a high-level functional block diagram of an exemplary computer system 400, in which aspects of the present disclosure, or portions thereof, may be implemented, e.g., as computer-readable code. For example, each of the exemplary devices and systems described above with respect to FIG. 4 can be implemented in computer system 400 using hardware, software, firmware, tangible computer readable media having instructions stored thereon, or a combination thereof and may be implemented in one or more computer systems or other processing systems. Hardware, software, or any combination of such may embody any of the modules and components in FIG. 4, as described above.

If programmable logic is used, such logic may execute on a commercially available processing platform or a special purpose device. One of ordinary skill in the art may appreciate that aspects of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described aspects. A processor device may be a single processor, a plurality of processors, or combinations thereof. Processor devices may have one or more processor “cores.”

Various aspects of the present disclosure, as described above in the examples of FIGS. 1-3 may be implemented using computer system 400, shown in FIG. 4. After reading this description, it will become apparent to a person skilled in the relevant art how to implement aspects of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some aspects, the order of operations may be rearranged without departing from the spirit of the disclosed subject matter.

For example, FIG. 4 depicts an example computer system 400 that may execute techniques presented herein, according to one or more aspects. Computer system 400 may typically be used to implement a server, such as user device 105, external system(s) 110, and/or server system 135.

Computer system 400 may include a data communication interface for packet data communication 460. The platform may also include a central processing unit (CPU) 420, in the form of one or more processors, for executing program instructions. The platform typically includes an internal communication bus 410, program storage, and data storage for various data files to be processed and/or communicated by the platform such as ROM 430 and RAM 440, although the computer system 400 often receives programming and data via network communications. The hardware elements, operating systems, and programming languages of such equipment are conventional in nature, and it is presumed that those skilled in the art are adequately familiar therewith. The computer system 400 also may include input and output ports 450 to connect with input and output devices such as keyboards, mice, touchscreens, monitors, displays, etc. Of course, the various computer platform functions may be implemented in a distributed fashion on a number of similar platforms, to distribute the processing load. Alternatively, the computer platforms may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as those used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It would also be apparent to one of skill in the relevant art that the present disclosure, as described herein, can be implemented in many different aspects of software, hardware, firmware, and/or the entities illustrated in the figures. Any actual software code with the specialized control of hardware to implement aspects is not limiting of the detailed description. Thus, the operational behavior of aspects will be described with the understanding that modifications and variations of the aspects are possible, given the level of detail presented herein.

It is to be understood that both the foregoing general description and the following detailed description are exemplary and explanatory only and are not restrictive of the disclosed aspects, as claimed.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for delivering video data, the computer-implemented method comprising:
receiving, by one or more processors, a first reference to a first video content item from a user device;
generating, by the one or more processors, a manifest request for a manifest associated with the first video content item, the manifest request comprising profile data associated with a user of the user device, wherein the profile data includes profile metadata;
transmitting, by the one or more processors, the manifest request to a server system;
in response to the transmitting, receiving, by the one or more processors, an additional video content item based on the manifest request from the server system, wherein the additional video content item includes metadata that matches the profile metadata;
encoding, by the one or more processors, the additional video content item with an embedded watermark, wherein the embedded watermark includes the profile metadata and a unique identifier associated with the user; and
transmitting, by the one or more processors, the encoded additional video content item to the user device.

2. The computer-implemented method of claim 1, the computer-implemented method further comprising:
receiving, by the one or more processors, a copy of the unique identifier from the user device.

3. The computer-implemented method of claim 2, wherein receiving the copy of the unique identifier is responsive to the user device extracting the unique identifier from the embedded watermark.

4. The computer-implemented method of claim 1, the computer-implemented method further comprising:
storing, by the one or more processors, the encoded additional video content item in one or more data stores of the server system.

5. The computer-implemented method of claim 1, wherein encoding the additional video content item with the embedded watermark further comprises:
encoding, by the one or more processors, an embedded visible symbol into one or more frames of the additional video content item, wherein the embedded visible symbol includes a reference to an external resource.

6. The computer-implemented method of claim 1, the computer-implemented method further comprising:
updating, by the one or more processors, the manifest corresponding to the manifest request with the profile metadata and a location of the encoded additional video content item within the server system.

7. The computer-implemented method of claim 6, the computer-implemented method further comprising:
transmitting, by the one or more processors, the manifest to the user device.

8. A computer system for delivering video data, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
receiving, by one or more processors, a first reference to a first video content item from a user device;
generating, by the one or more processors, a manifest request for a manifest associated with the first video content item, the manifest request comprising profile data associated with a user of the user device, wherein the profile data includes profile metadata;
transmitting, by the one or more processors, the manifest request to a server system;
in response to the transmitting, receiving, by the one or more processors, an additional video content item based on the manifest request from the server system, wherein the additional video content item includes metadata that matches the profile metadata;
encoding, by the one or more processors, the additional video content item with an embedded watermark, wherein the embedded watermark includes the profile metadata and a unique identifier associated with the user; and
transmitting, by the one or more processors, the encoded additional video content item to the user device.

9. The computer system of claim 8, the functions further comprising:
receiving, by the one or more processors, a copy of the unique identifier from the user device.

10. The computer system of claim 9, wherein receiving the copy of the unique identifier is responsive to the user device extracting the unique identifier from the embedded watermark.

11. The computer system of claim 8, the functions further comprising:
storing, by the one or more processors, the encoded additional video content item in one or more data stores of the server system.

12. The computer system of claim 8, wherein encoding the additional video content item with the embedded watermark further comprises:
encoding, by the one or more processors, an embedded visible symbol into one or more frames of the additional video content item, wherein the embedded visible symbol includes a reference to an external resource.

13. The computer system of claim 8, the functions further comprising:
updating, by the one or more processors, the manifest corresponding to the manifest request with the profile metadata and a location of the encoded additional video content item within the server system.

14. The computer system of claim 12, the functions further comprising:
transmitting, by the one or more processors, the manifest to the user device.

15. A non-transitory computer-readable medium containing instructions for delivering video data, the instructions comprising:
receiving a first reference to a first video content item from a user device;
generating a manifest request for a manifest associated with the first video content item, the manifest request comprising profile data associated with a user of the user device, wherein the profile data includes profile metadata;
transmitting the manifest request to a server system;
in response to the transmitting, receiving an additional video content item based on the manifest request from the server system, wherein the additional video content item includes metadata that matches the profile metadata;
encoding the additional video content item with an embedded watermark, wherein the embedded watermark includes the profile metadata and a unique identifier associated with the user; and
transmitting the encoded additional video content item to the user device.

16. The non-transitory computer-readable medium of claim 15, the instructions further comprising:
receiving a copy of the unique identifier from the user device.

17. The non-transitory computer-readable medium of claim 16, wherein receiving the copy of the unique identifier is responsive to the user device extracting the unique identifier from the embedded watermark.

18. The non-transitory computer-readable medium of claim 15, the instructions further comprising:
storing the encoded additional video content item in one or more data stores of the server system.

19. The non-transitory computer-readable medium of claim 15, wherein encoding the additional video content item with the embedded watermark further comprises:
encoding an embedded visible symbol into one or more frames of the additional video content item, wherein the embedded visible symbol includes a reference to an external resource.

20. The non-transitory computer-readable medium of claim 15, the instructions further comprising:
updating the manifest corresponding to the manifest request with the profile metadata and a location of the encoded additional video content item within the server system.
